(19) United States
(12) Patent Application Publication
(10) Pub. No.: US 2012/0216634 A1
(43) Pub. Date: Aug. 30, 2012

(54) METHOD FOR CHECKING ENGAGEMENT OF A PINION OF A STARTER SYSTEM

(75) Inventors: Apostolos Tsakiris, Ludwigsburg (DE); Jie Ge, Stuttgart-Hausen (DE); Stefan Tumback, Stuttgart (DE)

(73) Assignee: Sony Corporation, Tokyo (JP)

(21) Appl. No.: 13/394,291

(22) PCT Filed: Aug. 3, 2010
(86) PCT No.: PCT/EP10/61275

§ 371 Date: May 16, 2012

(30) Foreign Application Priority Data
Sep. 30, 2009 (DE) 10 2009 045 159.5

(51) Int. Cl. F02N 15/06; G01M 15/00

(52) U.S. Cl. 74/6; 73/114.59

(57) ABSTRACT

A method for checking engagement of a pinion of a starter system with a ring gear of a drive unit to be started, including measuring a variable indicating a speed of the pinion or a speed of the drive unit to be started, and checking the engagement on the basis of the measured variable.

### FIELD OF THE INVENTION

The present invention relates to starter systems, in particular, start-stop systems.

### BACKGROUND INFORMATION

Starter systems, in particular, pinion-type starters, in which a pinion is engaged with a ring gear connected to a crankshaft of an internal combustion engine, are generally used for starting non-running, internal combustion engines. The pinion is usually driven by an electric motor, so that the combustion engine may be started via pinion-ring gear engagement.

Starter systems of the type mentioned above are employed, in particular, in so-called start-stop systems, which are used in modern vehicles having a so-called automatic start-stop mechanism. In this connection, the combustion engine is shut off when the vehicle is stationary and, for example, restarted in order to drive off.

A further development of the above-mentioned starter systems relates to electronic control of the electric motors; in addition to the starter, the starter system also including a starter-control unit or relay-control unit, so that the engagement and the starting or rotating of the pinion are carried out separately from one another, thereby achieving an optimized start-stop function having an increased level of comfort.

However, the separate control of the engaging operation, in which the pinion is engaged with the ring gear, and of the starting operation, in which the pinion is set into rotational motion by the electric motor, is susceptible to error, in particular, when the pinion and the ring gear are not synchronized. For example, if the speed of the combustion engine or the starter pinion is too high, then, due to the lack of synchronization, a collision may occur upon arrival of the starter pinion at the ring gear of the combustion engine, which may cause the destruction of the starter pinion.

Such an error typically occurs, for example, during engagement while the combustion engine is running down, or during the so-called pre-start, in which the pinion is engaged prior to starting the combustion engine. For example, in the case of engagement during the running-down, the advancement of the pinion may be activated at an incorrect time, at which, e.g., a circumferential speed of the ring gear of the combustion engine is still much higher than that of the starter pinion. On the other hand, in the pre-start phase, the starter may be started prior to engagement of the gear teeth of the pinion with the ring gear of the combustion engine, so that the pinion only rubs against the rim of the ring gear and is not inserted, which means that in addition to an increased noise level, increased wear or even destruction of the starter pinion may be expected.

### SUMMARY

In accordance with the example embodiment of the present invention, in order to prevent the above-mentioned problems, an additional check of the engagement of a pinion of a starter system with a ring gear of a source of motive power to be started, in particular, an internal combustion engine, is carried out. This check may be based, for example, on a measurement of a speed of the source to be started, after the finishing of the engaging operation, and, for example, after the electric motor of the starter is started, in order to set the pinion into a rotational motion. In this connection, if, for example, no noticeable rotation is detected, then it may be concluded that the engaging operation was flawed. This check may also take place during the engaging, so that in the case of a detected failure to engage, the engaging operation may be terminated in order to prevent consequential damage.

According to one aspect, the present invention relates to a method for checking engagement of a pinion of a starter system with a ring gear of a drive unit to be started, in particular, an internal combustion engine, having the steps of measuring a variable indicating a speed of the pinion and/or a speed of the drive unit to be started, and checking the engagement of the pinion on the basis of the respective, measured variable or the two measured variables.

According to one specific embodiment, the method includes comparing the variable indicating the speed of the pinion to the variable indicating the speed of the drive unit to be started, in order to check the engagement. Therefore, any possible failure to engage may be advantageously detected on the basis of a differential speed.

According to one specific embodiment, the method includes comparing the variable indicating the speed of the pinion and/or the variable indicating the speed of the drive unit to be started to a threshold value, in order to check the engagement. The threshold value may be stored as a reference value in a memory, for example, so that the check may always be performed on the basis of a simple comparison.

According to a specific embodiment, the method includes initiating an engaging operation, in order to engage the pinion with the ring gear; and comparing the variable indicating the speed of the drive unit to be started to the variable indicating the speed of the pinion, or to a threshold value, in particular, to a reference speed or a voltage indicating a speed, in order to obtain a comparison result; and terminating the engaging operation, if the comparison result exceeds a predetermined threshold value, in particular, continuously exceeds the predetermined threshold value within a predetermined time interval. This counteracts damage to the pinion in an advantageous manner.

According to one specific embodiment, the pinion is set into a rotational motion, e.g., by an electric motor, prior to the measuring of the variable indicating the speed of the pinion or the speed of the drive unit to be started. Therefore, by rotating the pinion, it may be checked, in a simple manner, whether the ring gear, which may be coupled to a flywheel or to a shaft of the drive unit to be started, is also rotated.

According to one specific embodiment, the variable indicating the speed of the drive unit to be started is the speed of the drive unit to be started, for example, the speed of a shaft of the drive unit to be started, or an angular position of a piston of the drive unit to be started, which may be, for example, an internal combustion engine. Consequently, several utilizable criteria for checking the engagement of the pinion are provided in an advantageous manner.

According to a specific embodiment, the variable indicating the speed of the pinion is an electrical voltage induced due to a rotation of the pinion, in particular, a voltage induced in an electric motor of the starter system due to the rotation of the pinion, or a speed of the pinion, or a torque transmittable by the pinion. Thus, several other criteria may be utilized for checking the engagement.

According to a specific embodiment, the pinion is driven by an electric motor; an electrical voltage induced by an internal resistance of a coil of the electric motor being measured, in order to measure the variable indicating the speed of the pinion. In this manner, direct measurement of the speed of the pinion may be avoided in an advantageous manner.

According to a further aspect, the present invention relates to a start-stop system having a pinion, an electric motor for driving the pinion, a device for engaging the pinion with a ring gear of a drive unit to be started, e.g., an internal combustion engine, and a checking device for checking the engagement of the pinion on the basis of a variable indicating a speed of the pinion or a speed of the drive unit to be started.

According to one specific embodiment, the checking device is configured to implement the method of the present invention for checking the engagement.

According to a further aspect, the present invention relates to a computer program having a program code for executing the method for checking engagement of a pinion, when the computer program is run on a computer.

### BRIEF DESCRIPTION OF THE DRAWINGS

Additional exemplary embodiments of the present invention are explained with reference to the figures.

FIG. 1 shows a flow chart of a method for checking engagement of a pinion.

FIG. 2 shows a start-stop system.

### DETAILED DESCRIPTION OF EXAMPLE EMBODIMENTS

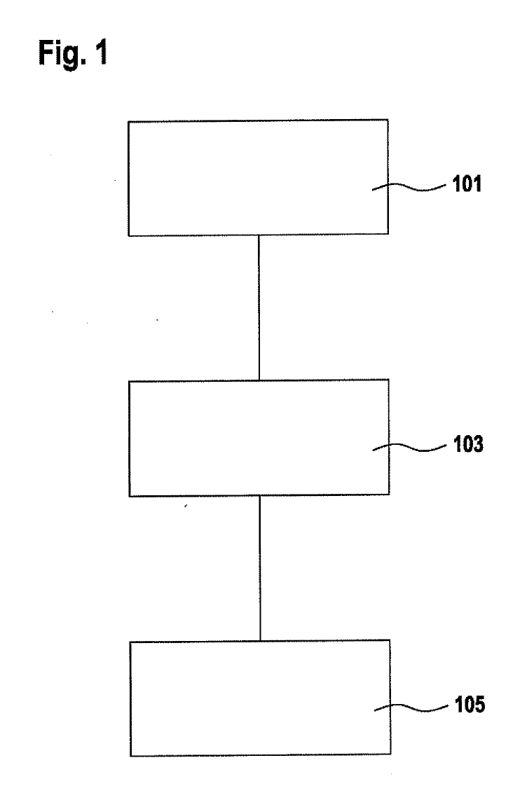

FIG. 1 shows a flow chart of a method for checking engagement of a pinion of a starter system with a ring gear of a drive unit to be started, having the step of measuring 101 a variable indicating the speed of the pinion or the speed of the drive unit to be started, and the step of checking 103 the engagement on the basis of the measured variable. The method may further include the step of comparing 105 the variables to one another or, in each instance, to a threshold value.

At the same time, the flowchart illustrated in FIG. 1 clarifies the structure of a device, which is set up and provided, e.g., in software or in hardware, to implement the method for checking the engagement.

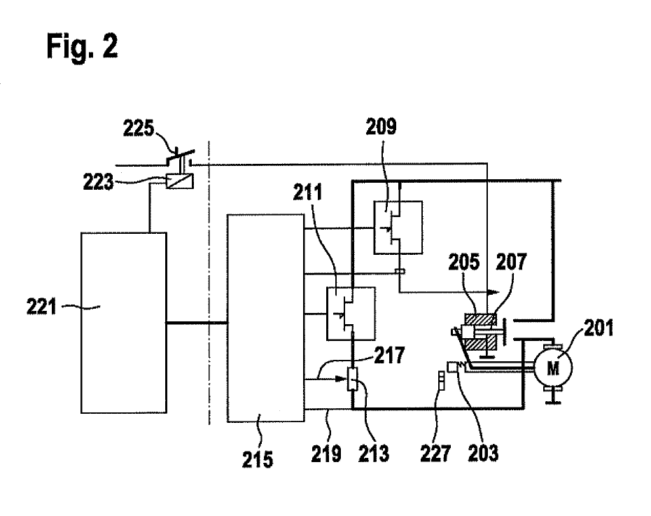

FIG. 2 shows a starter system having an electric motor 201, as well as a pinion 203. The starter system further includes an engagement coil 205, which is situated, for example, in a relay, as well as a starter coil 207 to begin the starting operation. In the same manner, starter coil 207 may be situated in a relay or in the above-mentioned relay.

The starter system may further have a first switch 209, for example, a transistor, and a second switch 211, which may be used for initiating or controlling the above-mentioned operations. Second switch 211 is connected, for example, to a terminal of electric motor 201; a resistor 213, e.g., a resistance Rᵥ, being situated between electric motor 201 and switch 211.

The starter system further includes a starter controller 215, which activates switches 209 and 211. The starter controller further includes a first terminal 217, which is connected to resistor 213, and a second terminal 219, which is connected to the line connected to electric motor 201.

A motor controller 221 is further provided, which is connected to starter controller 215, as well as to a relay 223, which opens or closes a switch 225. If switch 225 is closed, then a voltage applied to its input is supplied to coil 205 or to coil 207.

If the engaging is initiated, then pinion 203 is brought forward by a lever and a spring and, in the ideal case, is engaged with a ring gear 227 also illustrated in FIG. 2. After pinion 203 is rotated by electric motor 201, e.g., a speed of the internal combustion engine, which is already measured in a vehicle, may be measured. To measure a variable dependent on the speed of the pinion, the current and the voltage may be measured via terminals 219 and 217, in order to measure a voltage induced in motor 201 by a rotation of the pinion. This may be determined, for example, from a difference of the measured voltage and a product of the current and an internal resistance of motor 201.

Therefore, it is not necessary to conduct a measurement of a speed at the starter, in order to deduce its speed. As an alternative, an estimation may also be made using the control duration of the starter. The measurement of the speed of the electric motor does not have to be extremely accurate, so that an inaccuracy of ±10% is tolerable, which is particularly advantageous in the case of low speeds. In addition, the example embodiment of the present invention allows one to dispense with measuring the positions of the pinion and an engagement armature of the electric motor, which allows simple implementation.

In the case of engaging the pinion, e.g., during the running-down of the combustion engine, its speed may preferably be compared sporadically or continuously to an expected synchronous speed, which represents a threshold value. The engaging operation may be terminated, for example, when a maximum differential speed, which may also represent a threshold value, is exceeded. For example, in a pre-start phase, monitoring of the speed of the internal combustion engine may be carried out, in particular, when the starter is started; the starting operation being able to be terminated, if, for example, no rotation of a shaft or a flywheel or the ring gear of the combustion engine is detected. In addition, an overload of the starter, which may be caused, for example, by an instance of jamming, may also be monitored over time during the starting operation, which means that in the case of an instance of jamming, damage to the starter may be prevented by terminating the engaging operation.

The design of the present invention provides several protective functions, which may be advantageously utilized. For the case of engaging during the running-down, a first protective function may provide, e.g., after an activation of the engaging operation, a monitoring of the motor speed, which is read, for example, via the CAN (controller area network), e.g., in a 10 ms task, and is checked for a maximum difference, using an expected synchronous speed, which represents a threshold value. For example, if the differential speed continuously exceeds a limiting value Δn_max in a particular time interval, which may be, e.g., 30 ms, then the engaging operation may be terminated. The above-mentioned protective function may preferably be activated during the engaging operation.

A second protective function for the case of a pre-start phase may be defined, for example, as follows: after a particular time of, e.g., 150 ms after activation of the starting operation, while using the pre-start, e.g., while starting the starter in response to both key-starting and stop-start, the motor speed is read in, e.g., via CAN. If, for example, no motor speed greater than a threshold speed value of, for example, 20 rpm is detected after, at the latest, a further, determined time of, e.g., 50 ms, then the starting operation may be interrupted. Alternatively, it may also be checked if the drive unit to be started, e.g., an internal combustion engine, has or has covered a particular angular range of, e.g., 24° after a particular time of, e.g., 200 ms. At the same time, the second protective function also provides protection from an overload due to an instance of jamming of the combustion engine, since then, the required motor motion is also not reached within the predefined time.

According to a specific embodiment, the controllers 215 and 227 illustrated in FIG. 2 may be combined in a control unit, for example, in an engine control unit, which may be set up as software. The switches 209, 211 and 225 illustrated in FIG. 2 may be implemented, for example, as semiconductor switches or as relay switches.

The design of the present invention may be used in all conventional start-stop starter systems, in which the engaging and the starter operations are controlled separately. Such start-stop starters may be used, for example, in passenger cars or in so-called light CV's (CV: consumer vehicle).

1-11. (canceled)

12. A method for checking engagement of a pinion of a starter system with a ring gear of a drive unit to be started, comprising:
measuring at least one of a variable indicating a speed of the pinion, or a variable speed of the drive unit to be started; and
checking the engagement on the basis of the measured variable.

13. A method for checking engagement of a pinion of a starter system with a ring gear of a drive unit to be started, comprising:
measuring a variable indicating a speed of the pinion and a variable indicating a speed of the drive unit to be started; and
comparing the variable indicating the speed of the pinion to the variable indicating the speed of the drive unit to be started to check the engagement.

14. The method as recited in claim 12, further comprising:
comparing at least one of the variable indicating the speed of the pinion and the variable indicating the speed of the drive unit to be started to a threshold value to check the engagement.

15. The method as recited in claim 12, further comprising:
initiating an engaging operation to engage the pinion with the ring gear;
comparing the variable indicating the speed of the drive unit to be started to one of the variable indicating the speed of the pinion or to a threshold value to obtain a comparison result; and
terminating the engaging operation if the comparison result exceeds a predefined threshold value continuously within a predefined time interval.

16. The method as recited in claim 15, wherein the threshold value is one of a reference speed or a voltage indicating a speed.

17. The method as recited in claim 12, wherein prior to the measuring of the at least one of the variable indicating the speed of the pinion or the variable indicating the speed of the drive unit to be started, setting the pinion into a rotational motion.

18. The method as recited in claim 12, wherein the variable indicating the speed of the drive unit to be started is one of the speed of the drive unit to be started or an angular position of a piston of the drive unit to be started.

19. The method as recited in claim 18, wherein the drive unit is an internal combustion engine.

20. The method as recited in claim 12, wherein the variable indicating the speed of the pinion is one of an electrical voltage induced due to a rotation of the pinion, a voltage induced in an electric motor of the starter system, a speed of the pinion, or a torque transmittable by the pinion.

21. The method as recited in claim 12, wherein the pinion is driven by an electric motor, and to measure the variable indicating the speed of the pinion, an electrical voltage induced by an internal resistance of a coil of the electric motor is measured.

22. A start-stop system, comprising:
a pinion;
an electric motor to drive the pinion;
a device to engage the pinion with a ring gear of a drive unit to be started; and
a checking device to check engagement of the pinion based on a variable indicating one of a speed of the pinion or a speed of the drive unit to be started.

23. The start-stop system as recited in claim 22, wherein the drive unit is an internal combustion engine.

24. The start-stop system as recited in claim 22, wherein the checking device is configured to compare the variable indicating the speed of the pinion and the variable indicating the speed of the drive unit to check the engagement.

25. A storage device storing a computer program having a program code for checking engagement of a pinion of a starter system with a ring gear of a drive unit to be started, the program, when executed by a processor, causing the processor to perform the steps of:
measuring at least one of a variable indicating a speed of the pinion, or a variable speed of the drive unit to be started; and
checking the engagement on the basis of the measured variable.
